(19) United States
(12) Patent Application Publication
(10) Pub. No.: US 2023/0034124 A1
(43) Pub. Date: Feb. 2, 2023

(54) METRIC SUGGESTION FOR DATA OBJECTS

(71) Applicant: salesforce.com, inc., San Francisco, CA (US)

(72) Inventors: Aaron Popelka, San Francisco, CA (US); William Robert Jennings, II, Indianapolis, IN (US)

(21) Appl. No.: 17/387,005

(22) Filed: Jul. 28, 2021

(51) Int. Cl. G06Q 30/02; G06F 16/95

(52) U.S. Cl. CPC G06Q 30/0201; G06F 16/95

(57) ABSTRACT

Methods, apparatuses, and computer program products are described. A method may include generating a parent data object that may include child data objects. The method may include receiving a metric suggestion object configuration that identifies a selection of data from a set of child data objects of the child data objects. The method may include generating a metric suggestion object associated with the parent data object based on the metric suggestion object configuration. The method may include analyzing, with the metric suggestion object, the set of child data objects. The method may include suggesting a metric and a metric range based on the analyzing, and the metric and the metric range may be associated with the set of child data objects.

### FIELD OF TECHNOLOGY

The present disclosure relates generally to database systems and data processing, and more specifically to metric suggestion for data objects.

### BACKGROUND

A cloud platform (i.e., a computing platform for cloud computing) may be employed by many users to store, manage, and process data using a shared network of remote servers. Users may develop applications on the cloud platform to handle the storage, management, and processing of data. In some cases, the cloud platform may utilize a multi-tenant database system. Users may access the cloud platform using various user devices (e.g., desktop computers, laptops, smartphones, tablets, or other computing systems, etc.).

In one example, the cloud platform may support customer relationship management (CRM) solutions. This may include support for sales, service, marketing, community, analytics, applications, and the Internet of Things. A user may utilize the cloud platform to help manage contacts of the user. For example, managing contacts of the user may include analyzing data, storing and preparing communications, and tracking opportunities and sales.

The cloud platform may support data objects that represent various forms of content (e.g., electronic communications) for which the performance can be measured. For example, metrics associated with an email (e.g., click rate, open rate) may be measured and associated with the corresponding data objects in the cloud platform. These data objects may be used as child objects in a new parent object, and goals or metric thresholds may be established for the parent object.

### BRIEF DESCRIPTION OF THE DRAWINGS

FIG. 1 illustrates an example of a data processing system that supports metric suggestion for data objects in accordance with aspects of the present disclosure.

FIG. 2 illustrates an example of a system diagram that supports metric suggestion for data objects in accordance with aspects of the present disclosure.

FIG. 3 illustrates an example of a system diagram that supports metric suggestion for data objects in accordance with aspects of the present disclosure.

FIG. 4 illustrates an example of a data object scheme that supports metric suggestion for data objects in accordance with aspects of the present disclosure.

FIG. 5 illustrates an example of a process flow that supports metric suggestion for data objects in accordance with aspects of the present disclosure.

FIG. 6 shows a block diagram of an apparatus that supports metric suggestion for data objects in accordance with aspects of the present disclosure.

FIG. 7 shows a block diagram of a metric manager that supports metric suggestion for data objects in accordance with aspects of the present disclosure.

FIG. 8 shows a diagram of a system including a device that supports metric suggestion for data objects in accordance with aspects of the present disclosure.

FIGS. 9 through 12 show flowcharts illustrating methods that support metric suggestion for data objects in accordance with aspects of the present disclosure.

### DETAILED DESCRIPTION

A platform such as a cloud-based platform supporting customer relationship management (CRM) features may be configured to support various data processing functions such as marketing or the like. For example, a marketing platform may support the generation of campaigns which may be a collection of data objects that represent various forms of content and the delivery methods and timing of such content (e.g., electronic communications, website layouts, promotional materials, etc.). The performance of data objects may be measured and tracked within the platform. For example, a data object representing an email or other electronic communication may be tracked for open and click rate, and a website layout may be tracked for unique traffic over a time period. An administrator of a marketing platform may define goals for the campaign (e.g., thresholds associated with certain measurable metrics), which may represent aggregate goals for one or more of the data objects that make up the campaign. The type of goal and the numerical range associated with the metric may depend on the type of data object being measured (e.g., an electronic communication may have different metrics than a website layout).

A marketing platform may support the generation of a new marketing campaign. A new marketing campaign may be structured as a parent data object in a database. In some cases, data objects from a previous marketing campaign may be reused for the new campaign and may be structured as child data objects to the parent object representing the new campaign. For example, a data object representing one or more emails used in a previous marketing campaign may be reused as a child data object in a new marketing campaign. An administrator may define goals for the new campaign (e.g., average click rate, conversion rate, etc.). However, there is currently no way to leverage the measured performance of data objects from a previous campaign to guide the process of establishing goals for a new campaign. As such, an administrator may define goals for a new marketing campaign that are inappropriate (e.g., too high or too low), which can lead to wasted resources among other inefficiencies.

To reduce or eliminate inaccuracies in generation of metrics or goals associated with child data objects of a campaign data object, the platform may be configured to present various suggested goals to a user for the child data objects of the campaign object upon creating a new campaign data object. These goals may be suggested based on a number of factors, including a selected campaign template, particular child objects used in the campaign object, metrics collected from previous campaign objects or child objects (e.g., industry specific practices, or other factors). In addition, an administrator may configure or otherwise choose what types of factors may or may not be relevant to a particular campaign, further customizing the goals. Additionally, a visualization method may be suggested based on the goal that is being suggested for the associated child data object.

In some examples, an application server may generate one or more metric suggestions based on a variety of factors, including information found in child data objects of a parent data object. In some examples, an application server may generate a parent data object that may include one or more child data objects. The parent data object may be associated with a marketing campaign, and the one or more child data objects may be associated with one or more aspects of the marketing campaign. The application server may receive a metric suggestion object configuration that may identify a selection of data from the child data objects. In some examples, a portion or all of the child data objects may be identified. The application server may generate a metric suggestion object associated with the parent data object based on the metric suggestion object configuration. The application server may analyze, with the metric suggestion object, the child data objects. For example, the application server may analyze the child data objects, associated data, or both, to identify data in the child data objects that may be relevant to automated suggestion of metrics associated with the parent data object. The application server may suggest a metric and a metric range based on the analyzing, and the metric and the metric range may be associated with the set of child data objects. In this way, the application server may reduce or eliminate technical problems present in which existing approaches to metric generation, tracking, and management in database systems with large data amounts or scales is not possible. Additionally or alternatively, the approaches described herein may leverage large amounts of data (e.g., past performance, past metrics, or other information) to select, measure, determine, compute, or otherwise obtain improved metrics, metric ranges, metric visualizations, or other elements as described herein. Further, the approaches here may also select, measure, determine, compute, or otherwise obtain connections or inferences between data objects to select, measure, determine, compute, or otherwise obtain improved metrics, metric ranges, metric visualizations, or other elements as described herein.

In some examples, the application server may use one or more prior metrics to better determine or suggest metrics. For example, the application server may identify a prior metric present in the child data objects, and may perform various actions (e.g., transforming the prior metric from a first metric type to second metric type, determine average values, determine statistical deviations, determine metric ranges, modifying the prior metric based on various factors, etc.). Further, the application server may identify a metric type of a metric to be suggested, and the application server may suggest a metric range based on such a metric type. The application server may select, measure, determine, compute, or otherwise obtain a visualization method for the metric, the metric range, or both based on one or more factors (e.g., the analysis, a type of the metric, or a combination thereof). In some examples, the application server may receive user input including a selection of a set of child data objects, a selection of data from the child data objects, a selection of data from one or more other sources, or a combination thereof. In some examples, the application server may also take into account an industry type that may be associated with one or more of the child data objects, and may select, measure, determine, compute, or otherwise obtain the metric and the metric range based on the industry type. In some examples, the suggested metric may include various measurements, data, or other information, such as an email send rate, an email open rate, a click rate, an unsubscribe rate, a total conversion value, a number of pageviews, a conversion rate, a number of goal completions, or a combination thereof.

Aspects of the disclosure are initially described in the context of an environment supporting an on-demand database service. Aspects of the disclosure are illustrated by and described with reference to system diagrams, a data object scheme, and a process flow. Aspects of the disclosure are further illustrated by and described with reference to apparatus diagrams, system diagrams, and flowcharts that relate to metric suggestion for data objects.

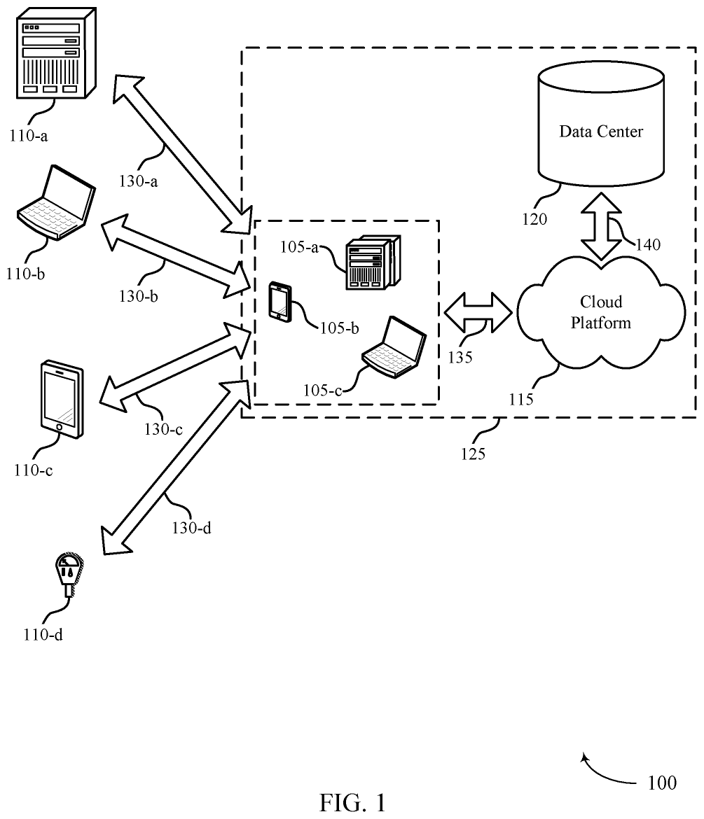

FIG. 1 illustrates an example of a system 100 for cloud computing that supports metric suggestion for data objects in accordance with various aspects of the present disclosure. The system 100 includes cloud clients 105, contacts 110, cloud platform 115, and data center 120. Cloud platform 115 may be an example of a public or private cloud network. A cloud client 105 may access cloud platform 115 over network connection 135. The network may implement transfer control protocol and internet protocol (TCP/IP), such as the Internet, or may implement other network protocols. A cloud client 105 may be an example of a user device, such as a server (e.g., cloud client 105-a), a smartphone (e.g., cloud client 105-b), or a laptop (e.g., cloud client 105-c). In other examples, a cloud client 105 may be a desktop computer, a tablet, a sensor, or another computing device or system capable of generating, analyzing, transmitting, or receiving communications. In some examples, a cloud client 105 may be operated by a user that is part of a business, an enterprise, a non-profit, a startup, or any other organization type.

A cloud client 105 may interact with multiple contacts 110. The interactions 130 may include communications, opportunities, purchases, sales, or any other interaction between a cloud client 105 and a contact 110. Data may be associated with the interactions 130. A cloud client 105 may access cloud platform 115 to store, manage, and process the data associated with the interactions 130. In some cases, the cloud client 105 may have an associated security or permission level. A cloud client 105 may have access to certain applications, data, and database information within cloud platform 115 based on the associated security or permission level, and may not have access to others.

Contacts 110 may interact with the cloud client 105 in person or via phone, email, web, text messages, mail, or any other appropriate form of interaction (e.g., interactions 130-a, 130-b, 130-c, and 130-d). The interaction 130 may be a business-to-business (B2B) interaction or a business-to-consumer (B2C) interaction. A contact 110 may also be referred to as a customer, a potential customer, a lead, a client, or some other suitable terminology. In some cases, the contact 110 may be an example of a user device, such as a server (e.g., contact 110-a), a laptop (e.g., contact 110-b), a smartphone (e.g., contact 110-c), or a sensor (e.g., contact 110-d). In other cases, the contact 110 may be another computing system. In some cases, the contact 110 may be operated by a user or group of users. The user or group of users may be associated with a business, a manufacturer, or any other appropriate organization.

Cloud platform 115 may offer an on-demand database service to the cloud client 105. In some cases, cloud platform 115 may be an example of a multi-tenant database system. In this case, cloud platform 115 may serve multiple cloud clients 105 with a single instance of software. However, other types of systems may be implemented, including—but not limited to—client-server systems, mobile device systems, and mobile network systems. In some cases, cloud platform 115 may support CRM solutions. This may include support for sales, service, marketing, community, analytics, applications, and the Internet of Things. Cloud platform 115 may receive data associated with contact interactions 130 from the cloud client 105 over network connection 135, and may store and analyze the data. In some cases, cloud platform 115 may receive data directly from an interaction 130 between a contact 110 and the cloud client 105. In some cases, the cloud client 105 may develop applications to run on cloud platform 115. Cloud platform 115 may be implemented using remote servers. In some cases, the remote servers may be located at one or more data centers 120.

Data center 120 may include multiple servers. The multiple servers may be used for data storage, management, and processing. Data center 120 may receive data from cloud platform 115 via connection 140, or directly from the cloud client 105 or an interaction 130 between a contact 110 and the cloud client 105. Data center 120 may utilize multiple redundancies for security purposes. In some cases, the data stored at data center 120 may be backed up by copies of the data at a different data center (not pictured).

Subsystem 125 may include cloud clients 105, cloud platform 115, and data center 120. In some cases, data processing may occur at any of the components of subsystem 125, or at a combination of these components. In some cases, servers may perform the data processing. The servers may be a cloud client 105 or located at data center 120.

In some examples, the cloud platform 115 may generate a parent data object that may include one or more child data objects. The cloud platform 115 may receive a metric suggestion object configuration that may identify a selection of data from the child data objects. In some examples, a portion or all of the child data objects may be identified. The cloud platform 115 may generate a metric suggestion object associated with the parent data object based on the metric suggestion object configuration. The cloud platform 115 may analyze, with the metric suggestion object, the child data objects. For example, the cloud platform 115 may analyze the child data objects, associated data, or both, to identify data in the child data objects that may be relevant to automated suggestion of metrics associated with the parent data object. The cloud platform 115 may suggest a metric and a metric range based on the analyzing, and the metric and the metric range may be associated with the set of child data objects.

In some approaches to database systems and metric generation, various data objects may be separated or isolated, even though such data objects may contain information relevant to other data object and associated metric generation. Such an approach produces metrics that are not refined, are inaccurate, or not applicable to the data objects. Such metrics may be isolated to particular data, and may not provide a unified, comprehensive view of what the data may represent. Additionally, when dealing with data on a large scale, metric analysis and suggestion becomes difficult and cumbersome.

By implementing the approaches discussed herein, an administrator of a database system, cloud platform, application server, or other appropriate platform may generate metrics that are relevant to the data objects in the database system. Further, the approaches discussed herein may also take large amounts of data into account for metric generation. An application server may incorporate or consider these large amounts of data from various sources, including previous metrics associated with child data objects (e.g., a similar child data object associated with a different parent data object), previous metrics associated with other data objects (e.g., data objects associated with other database systems, parent data objects, or other sources), or other sources. In this way, the approaches described herein may generate metrics for the data objects that may be more accurate, relevant, and comprehensive.

For example, if an administrator that manages a parent data object (e.g., a parent data object associated with a marketing campaign), wishes to obtain accurate, relevant metrics for the parent data object, the administrator may employ an application server to generate such metrics (e.g., using large amounts of data present in the database system). The application server may generate such a parent data object with one or more child data objects for which the administrator may desire to generate metrics. The administrator may provide to the application server a selection of child data objects, associated data, or both, for the application server to use to generate the metrics associated with the child data objects. The application server may generate a data object, such as a metric suggestion object associated with the parent object. The application server may use the metric suggestion object to analyze child data objects, associated (or other) data, or both, and may then select, measure, determine, compute, generate or otherwise obtain, one or more metrics, ranges, visualizations, other elements, or a combination thereof based on the analysis. Such results may be incorporated into the parent data object, one or more child data objects, or a combination thereof, so that the application server may monitor the metrics and analyze data associated with the child data objects. The application server may select, measure, determine, compute, or otherwise obtain performance data associated with the parent data object (e.g., performance data or information associated with a marketing campaign) by comparing various pieces of data with the generated metrics. The administrator may then receive such generated metrics, ranges, visualizations, performance data, or other elements to better manage the parent data object (e.g., the marketing campaign associated with the parent data object).

It should be appreciated by a person skilled in the art that one or more aspects of the disclosure may be implemented in a system 100 to additionally or alternatively solve other problems than those described above. Furthermore, aspects of the disclosure may provide technical improvements to “conventional” systems or processes as described herein. However, the description and appended drawings only include example technical improvements resulting from implementing aspects of the disclosure, and accordingly do not represent all of the technical improvements provided within the scope of the claims.

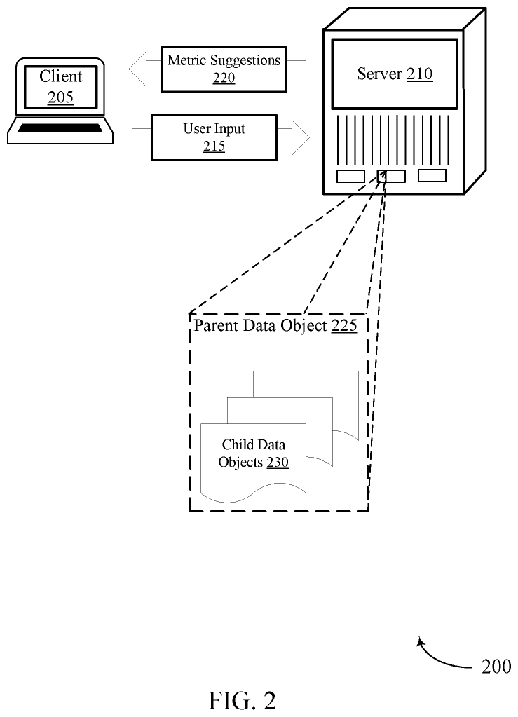

FIG. 2 illustrates an example of a system 200 that supports metric suggestion for data objects in accordance with aspects of the present disclosure. The system 200 may include a client 205 and a server 210 (e.g., an application server, cloud platform, or other appropriate computing platform) that may communicate, in some examples, to generate or suggest metrics by the approaches described herein. The client 205 may be an example of client 105 described in relation to FIG. 1, and the server 210 may be an example of a server associated with the cloud platform 115 or the data center 120 described in relation to FIG. 1. The server 210 may access, store, modify, or otherwise process the parent data object 225 for metric generation or suggestion in accordance with approaches described herein.

In some examples, the server 210 may generate, select, determine, compute, receive, or otherwise obtain the parent data object 225. The parent data object 225 may be a data object that may be associated with a campaign (e.g., a marketing campaign), and may store data associated with the campaign. The parent data object 225 may also provide for storage, manipulation, modification, or other processing of the data associated with the parent data object 225 (e.g., data associated with the marketing campaign). Such a parent data object 225 may provide a unified approach to management, storage, or processing of large amounts of data and child data objects 230 (e.g., data associated with a marketing campaign, for example).

In some examples, the server 210 may also generate, select, determine, compute, receive, or otherwise obtain one or more child data objects 230. In some examples, one or more child data objects 230 may be contained in a parent data object 225, or may not be contained in a parent data object 225. A child data object 230 may be a data object associated with an aspect of the parent data object 225 (e.g., an aspect of the marketing campaign). For example, a child data object 230 may provide for storage, manipulation, modification, or other processing of data associated with the child data object 230. For example, in the context of a marketing campaign, a child data object 230 may store, modify, or otherwise process data associated with electronic messages, documents, website content and layout, actions taken by message senders or recipients, sales data, consumer conversion data, prior metrics associated with one or more earlier marketing campaigns, or other data.

In some examples, the server 210 may receive user input 215 from the client 205. Such user input may include one or more commands related to the parent data object 225, the child data objects 230, or both. For example, the commands may be for creation of the parent data object 225, the child data objects 230, or both. In some examples, the commands may involve selecting one or more child data objects 230 to be associated with the parent data object 225. In some examples, the user input 215 may include a selection of one or more child data objects 230, one or more pieces of data associated with one or more child data objects 230, or a combination thereof to be used for metric generation.

In some examples, the server 210 may transmit or cause display of one or more metric suggestions 220. In some examples, the metric suggestions 220 may be transmitted or displayed to the client 205.

In some examples, the server 210 may generate a parent data object 225 that may include one or more child data objects 230. The server 210 may select, measure, determine, compute, or otherwise obtain a metric suggestion object configuration that may identify a selection of data from the child data objects 230. In some examples, a portion or all of the child data objects 230 may be identified, selected, measured, determined, computed, or otherwise obtained. The server 210 may generate a metric suggestion object associated with the parent data object 225 based on the metric suggestion object configuration. The server 210 may analyze, with the metric suggestion object, the child data objects 230. For example, the server 210 may analyze the child data objects 230, associated data, or both, to identify data in the child data objects 230 that may be relevant to automated suggestion of metrics associated with the parent data object. The server 210 may suggest a metric and a metric range based on the analyzing, and the metric and the metric range may be associated with the set of child data objects 230.

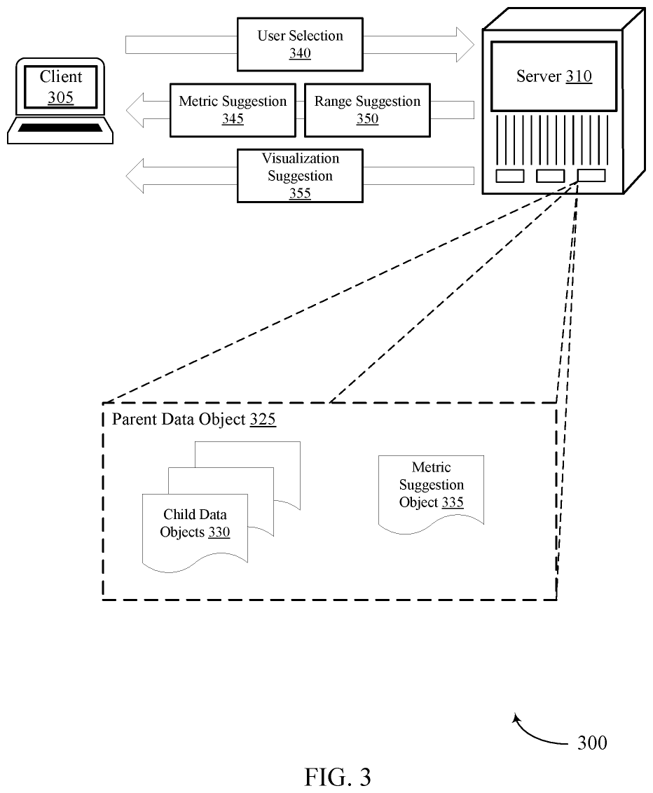

FIG. 3 illustrates an example of a system 300 that supports metric suggestion for data objects in accordance with aspects of the present disclosure. The system 300 may include a client 305 and a server 315 (e.g., an application server, cloud platform, or other appropriate computing platform) that may communicate, in some examples, to generate or suggest metrics by the approaches described herein. The client 305 may be an example of client 105 described in relation to FIG. 1, and the server 315 may be an example of a server associated with the cloud platform 115 or the data center 130 described in relation to FIG. 1.

In some examples, the server 310 may generate a parent data object 325 that may include one or more child data objects 330. The child data objects 330 may be examples of child data objects 230 described in relation to FIG. 2.

The server 310 may select, measure, determine, compute, or otherwise obtain a metric suggestion object configuration that may identify a selection of data from the child data objects 330. For example, such a configuration may identify one or more pieces of data from the child data objects 330 that may be used to generate one or more metric suggestions (e.g., metric suggestions, metric range suggestions, metric visualization suggestions, etc.). Additionally or alternatively, such a configuration may select, measure, determine, compute, or otherwise obtain one or more types of data that may be used for metric generation (e.g., historical data, previous metrics, previous performance indicators, industry types, information associated with a different parent data object, etc.). In some examples, a portion or all of the child data objects 330 may be identified, selected, measured, determined, computed, or otherwise obtained. For example, some child data objects 330 may be chosen for use in metric generation, while other child data objects 330 may be ignored. A rule, process, or procedure may select, measure, determine, compute, or otherwise obtain criteria for selection of the child data objects 330 to be used for metric generation and for inclusion in the metric suggestion object configuration. In some examples, the server 310 may receive a user selection 340 of one or more child data objects 330, one or more pieces of data (e.g., a subset of data from the child data objects 330), other information, or a combination thereof that may be incorporated into or associated with the metric suggestion object configuration.

In some examples, the server 310 may generate a metric suggestion object 335 associated with the parent data object 325 based on the metric suggestion object configuration. For example, the metric suggestion object configuration may select, measure, determine, compute, or designate which of the one or more child data objects 330 should be included in or utilized by the metric suggestion object 335. Such a metric suggestion object 335 may include or be associated with various functions or operations used to analyze data (e.g., data associated with the child data objects 330). For example, such functions or operations may include search functions, comparison functions, averaging functions, statistical deviation functions, or other functions or operations that may be used to analyze data. Further, such a metric suggestion object may include or be associated with one or more rules, processes, or procedures used for analyzing data (e.g., a rule that more heavily weights the results of an analysis of a child data object 330 that has more data as compared to an analysis of a child data object 330 has less data).

The server 310 may analyze, with the metric suggestion object, the child data objects 330. For example, the server 310 may analyze the child data objects 330, associated data, or both, to identify data or other elements in the child data objects 330 that may be relevant to automated suggestion of metrics associated with the parent data object 325. For example, a child data object 330 may be associated with email marketing, and may include information about a number of emails sent. In such a case, the server 310 may identify such information, and such information may be used as part of the metric generation process.

In some examples, the server 310 may suggest a metric and a metric range based on the analyzing, and the metric and the metric range may be associated with the set of child data objects 330. For example, the server 310 may use data or information gathered during analysis of the child data objects 330 to suggest a metric, a metric range, a metric visualization, or other metric information. For example, if the server 310 gathered information about the number of emails sent in an email marketing scenario, the server 310 may suggest a metric and a metric range for a future number of emails to be sent in the same or a different marketing scenario. In some examples, the server 310 may transmit or display the metric suggestion 345, the metric range suggestion 350, the metric visualization suggestion 355, or a combination thereof, to the client 305.

In some examples, the metrics suggested, generated, selected, measured, determined, computed, or otherwise obtained may include one or more of the following: sends, delivery rate, deliveries, open rate, opens, unique opens, click rate, clicks, unique clicks, unsubscribe rate, unsubscribes, unique unsubscribes, total conversion value, pageviews by device, email conversion rate, bounce performance, engagement by location, conversion rate, roas attribution, goal completions, goal conversion rate, goal value, total abandonment rate, ecommerce conversion rate, average order value, transactions, local revenue, or a combination thereof. Such metrics may describe a number of times an email was sent, a number of sends minus a number of bounces divided by the a number of sends, a number of sends minus a number of bounces, a number of unique opens divided by the number of deliveries, a number of opens counted when someone renders the images of an email in their email client, previewing emails without downloading images, or clicking a link is not recorded as an open, a number of unique opens that counts the a number of opens by distinct users, any other attribute about unique opens that shows information relevant to the first open for that user, a number of unique clicks divided by the a number of delivered emails (e.g., deliveries), a number of times a link in an email was clicked, a number of unique clicks that counts a number of clicks by distinct users, any other attribute about unique clicks that shows information relevant to the first click for that user, a number of unique unsubscribes divided by the a number of sends, a number of unsubscribes. an unsubscribe is a status signifying a subscriber has either unsubscribed from a communication or has been unsubscribed by another, a number of unique unsubscribes (e.g., measured by the first time a distinct user unsubscribes, even if they unsubscribe multiple times) aggregate conversion value, pageviews by device type, email conversion rate over time, breakdown of hard bounces, soft bounces, and block bounces, opens shown by geolocation, conversion behavior funnel, return on ad spend by device type, total a number of completions for all goals defined in the profile, the percentage of sessions which resulted in a conversion to at least one of the goals, total numeric value for all goals defined in the profile, goal abandonment rate, the average a number of transactions in a session, the average revenue of an ecommerce transaction, the total a number of transactions, transaction revenue in local currency, or a combination thereof.

In some examples, the server 310 may suggest, generate, select, measure, determine, compute, or otherwise obtain a metric range to be suggested (e.g., as a metric range suggestion 350). For example, if the server 310 has suggested, generated, selected, measured, determined, computed, or otherwise obtained a metric, the server 310 may also suggest, generate, select, measure, determine, compute, or otherwise obtain a metric range that may be associated with the metric, and, in some examples, the metric range may be suggested, generated, selected, measured, determined, computed, or otherwise obtained based on the metric itself. For example, if a generated metric is to send emails to 10,000 recipients in a month, the metric range may be from 9,500 recipients to 10,500 recipients. The server 310 may suggest, generate, select, measure, determine, compute, or otherwise obtain the metric range based on one or more factors, including a metric type. For example, a metric range may be different for a number of emails sent versus an email unsubscribe rate. Based on such a type difference, a different range may be suggested, generated, selected, measured, determined, computed, or otherwise obtained (e.g., a range for a number of emails sent may be large, whereas a range for an unsubscribe rate may be narrow).

In some examples, the server 310 may suggest, generate, select, measure, determine, compute, or otherwise obtain a visualization method for the metric, the metric range, or both. Such a visualization method may be suggested, generated, selected, measured, determined, computed, or otherwise obtained based on the analysis of the child data objects 330, the type of the metric, or a combination thereof. For example, a visualization type for a number of times an email was sent may be a bar graph type of visualization, whereas a visualization type for a delivery rate metric may be a line graph type of visualization. Various visualization types that may be suggested, generated, selected, measured, determined, computed, or otherwise obtained may include a bar graph, a line graph, a hero graph, a pie chart, a donut chart, a map, a sankey visualization, other visualization types, or a combination thereof. In some examples, a rule, process, or procedure may inform how the visualization method may be suggested, generated, selected, measured, determined, computed, or otherwise obtained. In some examples, a metric may be associated with one or more visualization methods or approaches, and the visualization method may be suggested, generated, selected, measured, determined, computed, or otherwise obtained based on such an association.

In some examples, the server 310 may display the metric suggestion 345, the range suggestion 350, the visualization suggestion 355, or a combination thereof, in a user interface accessible by the client 305. In some examples, such a user interface may be a web-based interface, accessible by the client 305 over the internet. In other examples, a user interface may be contained within a local area network or accessible via a virtual private network.

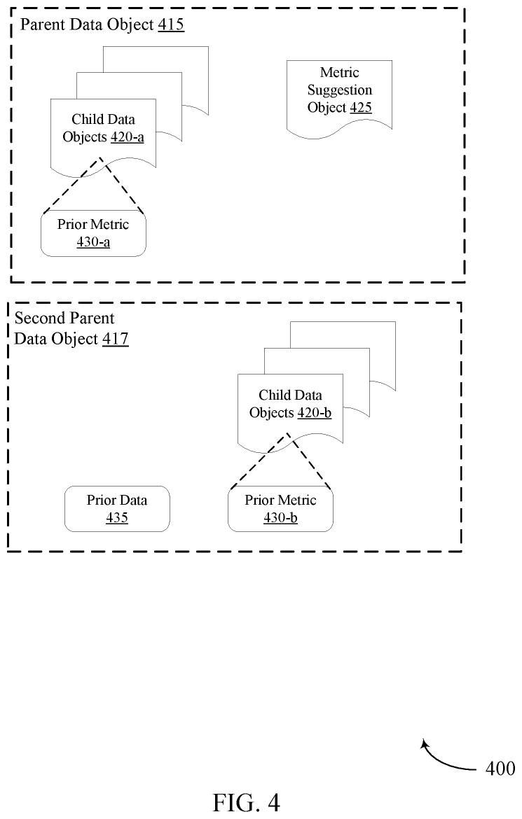

FIG. 4 illustrates an example of a data object scheme 400 that supports metric suggestion for data objects in accordance with aspects of the present disclosure. The data object scheme 400 may include a parent data object 415, a second parent data object 417, child data objects 420, a metric suggestion object 425, one or more prior metrics 430, and prior data 435. In some examples, the parent data object 415 may be a data object generated by a server as discussed herein. In some examples, the second parent data object 417 may be associated with, for example, a previous marketing campaign performed by the same organization, user, or client. Additionally or alternatively, the second parent data object 417 may be associated with, for example, a previous or current marketing campaign performed by a related or unrelated organization, user, or client. Though some objects are described or depicted as being associated with or contained within other objects, they may also be associated with or contained within different objects, or not associated or contained within any other objects.

In some examples, a server or other computing platform (e.g., the server 315 discussed in relation to FIG. 3, the server 210 discussed in relation to FIG. 2, or the cloud platform 115 discussed in relation to FIG. 1) may use one or more prior metrics as one or more factors to suggest, generate, select, measure, determine, compute, or otherwise obtain a metric, a metric range, a metric visualization, or a combination thereof. For example, the server may utilize prior metric 430-a as a factor to suggest, generate, select, measure, determine, compute, or otherwise obtain a metric associated with the child data objects 420-a or the parent data object 415. In some examples, the server may select, measure, determine, compute, or otherwise obtain a metric type associated with the prior metric 430-a. In some cases, the prior metric 430-a may be associated with a previous performance of a selection of data from the child data objects 420-a. For example, one or more of the child data objects 420-a may be associated with a previous email marketing campaign and may include information about a number of emails sent in the course of the email marketing campaign.

In some examples, the server may transform the prior metric 430-a from one metric type to another to suggest, generate, select, measure, determine, compute, or otherwise obtain the metric. For example, in a case of email marketing, a prior metric 430-a may be associated with a click rate, and the prior metric 430-a may be transformed into an unsubscribe rate. The server may transform the prior metric 430-a based on an analysis of the child data objects 420-a, the prior metric 430-a, one or more additional factors, or a combination thereof. For example, in the course of such an analysis, the server may select, measure, determine, compute, or otherwise obtain a result that the metric type of the prior metric 430-a may be transformed into a second metric type.

In some examples, the server may select, measure, determine, compute, or otherwise obtain an average value for the prior metric, and the average value may be selected, measured, determined, computed, or otherwise obtained based on previous performance of a selection of data (e.g., a selection of data associated with one or more of the child data objects 420-a, the child data objects 420-b, the prior data 435, or a combination thereof). In some examples, the average value may be suggested, generated, or selected as the metric (e.g., the metric suggestion 345 transmitted or displayed to the client 305 as described in relation to FIG. 3). In some examples, the server may select, measure, determine, compute, or otherwise obtain a statistical deviation (e.g., a standard deviation) from the average value. Such a deviation may be suggested, generated, selected, measured, determined, computed, or otherwise obtained based on previous performance of a selection of data (e.g., a selection of data associated with one or more of the child data objects 420-a, the child data objects 420-b, the prior data 435, or a combination thereof). In some examples, the server may suggest, generate, select, measure, determine, compute, or otherwise obtain one or more limits of a metric range based on the statistical deviation, a metric type of the metric, or a combination thereof. For example, the server may calculate a standard deviation from an average value for a set of performance data, and the server may establish an upper limit of the metric range corresponding with a value located one standard deviation above the average value and may establish a lower limit of the metric range corresponding with a value located one standard deviation below the average value. The server may employ other combinations of reference values, deviation types or calculations, and metric ranges.

In some examples, the server may modify a prior metric based on one or more factors, including a second prior metric, a number of previous metrics measured, a metric comprised in a child data object of a second parent data object, a predetermined rate of change, an industry type, or a combination thereof. For example, the server may modify the prior metric 430-a based on the prior metric 430-b. In such an example or in other examples, the prior metric 430-b may include information relevant or associated with information included in the prior metric 430-a. The server may suggest, generate, or select the modified prior metric 430-a as the metric to be transmitted, displayed, or indicated to the client, user, or organization.

In some examples, the server may take additional factors into account to suggest, generate, select, measure, determine, compute, or otherwise obtain a metric, a metric range, a metric visualization, or a combination thereof. For example, the server may determine an industry type that may be associated with the child data objects 420-a (e.g., manufacturing, travel/tourism, real estate, etc.). The server may determine an amount of prior data, such as prior data 435, that may be available from one or more prior parent data objects (e.g., the second parent data object 417). The server may select, measure, determine, compute, or otherwise obtain a prior data threshold, and may compare the amount of prior data 435 with the threshold. In some examples, the server may suggest, generate, select, measure, determine, compute, or otherwise obtain the metric, metric range, metric visualization, or a combination thereof based on the industry type and the amount or prior data 435 exceeding, meeting, or not exceeding the threshold. For example, the server may determine that the amount of prior data 435 may not result in an accurate or desirable metric, and may include the industry type as one factor for the metric generation.

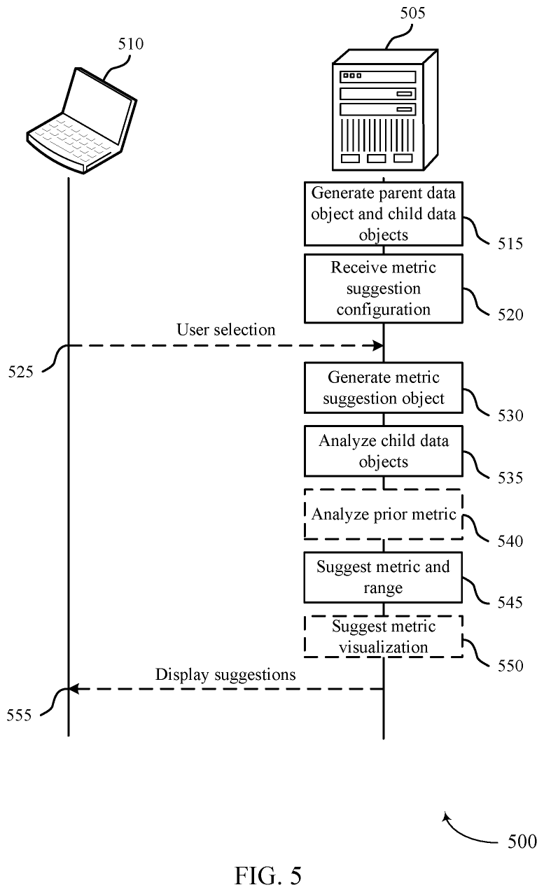

FIG. 5 illustrates an example of a process flow 500 that supports metric suggestion for data objects in accordance with aspects of the present disclosure. The process flow 500 may implement various aspects of the present disclosure described with reference to FIGS. 1-4. The process flow 500 may involve a server 505 and a client 510. In some examples, the server 505 may be configured with a metric generation or management capability as described herein.

In the following description of the process flow 500, the operations performed by or between the server 505 and the client 510 may be performed in different orders or at different times. Some operations may also be left out of the process flow 500, or other operations may be added. Although the server 505 and the client 510 are shown performing the operations of the process flow 500, some or all operations may also be performed by one or more other devices or platforms.

At 515, the server 505 may generate a parent data object that may include a plurality of child data objects. At 520, the server 505 may receive a metric suggestion object configuration that may identify a selection of data from a set of child data objects of the plurality of child data objects. At 525, the server 505 may receive a user selection of the set of child data objects and the selection of data from the set of child data objects. In some examples, the selection of data may include a subset of data from the set of child data objects. For example, if the data object represented emails, a selection of data from the data object may represent a subset of the emails associated with the data object. At 530, the server 505 may generate a metric suggestion object associated with the parent data object based on the metric suggestion object configuration. At 535, the server 505 may analyze, with the metric suggestion object, the set of child data objects.

At 540, the server 505 may analyze a prior metric or perform one or more operations associated with the prior metric. In some examples, the server 505 may determine a first metric type associated with a prior metric present in one or more of the set of child data objects. In some examples, the prior metric may be associated with a previous performance of the selection of data from the set of child data objects. In some examples, the server 505 may transform the prior metric from the first metric type to a second metric type based at least in part on the analyzing. In some examples, the server 505 may determine an average value for the prior metric based on the previous performance of the selection of data. In some examples, the server 505 may determine a statistical deviation from the average value based at least in part on the previous performance of the selection of data. In some examples, the server 505 may modify the prior metric based on a second prior metric, a number of previous metrics measured, a metric comprised in a child data object of a second parent data object, a predetermined rate of change, an industry type, or a combination thereof. In some examples, the server 505 may determine an industry type associated with the set of child data objects. In some examples, the server 505 may determine an amount of prior data available from one or more prior parent data objects. In some examples, the server 505 may compare the amount of prior data with a prior data threshold.

At 545, the server 505 may suggest a metric and a metric range based on the analyzing, wherein the metric and the metric range are associated with the set of child data objects. In some examples, the server 505 may suggest the average value as the metric. In some examples, the server 505 may suggest an upper limit of the metric range and a lower limit of the metric range based on the statistical deviation and a metric type of the metric. In some examples, the server 505 may suggest the modified prior metric as the metric. In some examples, the server 505 may suggest the metric and the metric range based on the determined industry type and the amount of prior data being less than or equal to the prior data threshold. In some examples, the suggested metric may include an email send rate, an email open rate, a click rate, an unsubscribe rate, a total conversion value, a number of pageviews, a conversion rate, a number of goal completions, or a combination thereof.

At 550, the server 505 may suggest a visualization method for the metric and the metric range based on the analysis, a type of the metric, or a combination thereof. At 555, the server 505 may cause for display in a user interface an indication of the metric and an indication of the metric range displayed within the metric suggestion object.

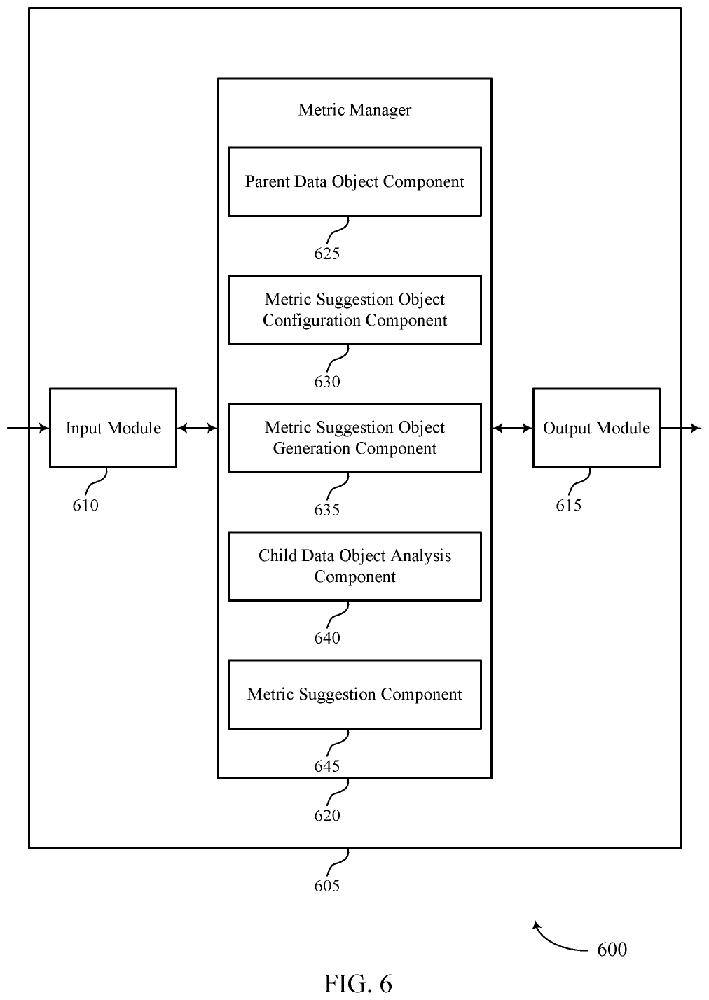

FIG. 6 shows a block diagram 600 of a device 605 that supports metric suggestion for data objects in accordance with aspects of the present disclosure. The device 605 may include an input module 610, an output module 615, and a metric manager 620. The device 605 may also include a processor. Each of these components may be in communication with one another (e.g., via one or more buses).

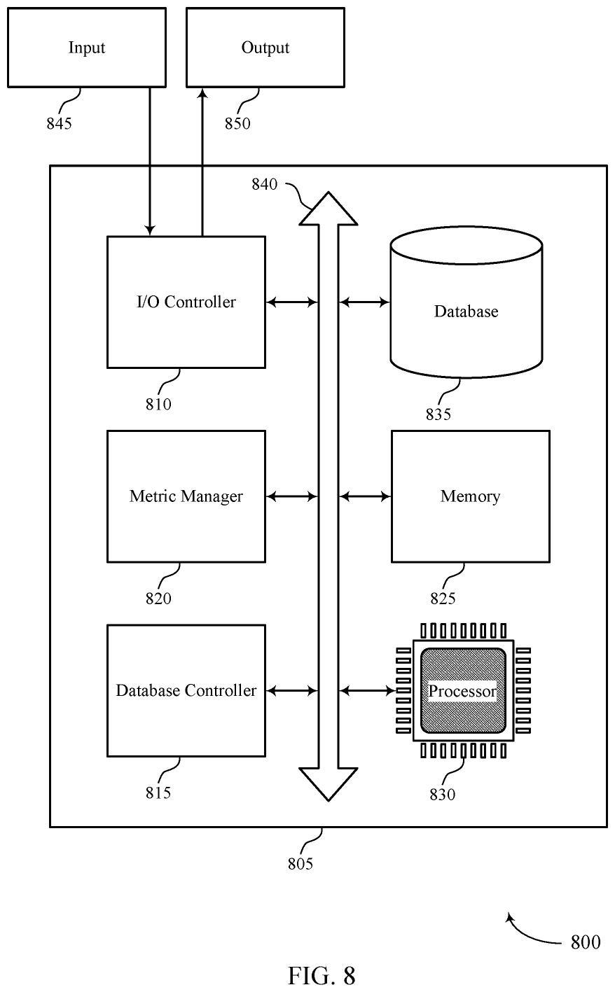

The input module 610 may manage input signals for the device 605. For example, the input module 610 may identify input signals based on an interaction with a modem, a keyboard, a mouse, a touchscreen, or a similar device. These input signals may be associated with user input or processing at other components or devices. In some cases, the input module 610 may utilize an operating system such as iOS®, ANDROID®, MS-DOS®, MS-WINDOWS®, OS/2®, UNIX®, LINUX®, or another known operating system to handle input signals. The input module 610 may send aspects of these input signals to other components of the device 605 for processing. For example, the input module 610 may transmit input signals to the metric manager 620 to support metric suggestion for data objects. In some cases, the input module 610 may be a component of an I/O controller 810 as described with reference to FIG. 8.

The output module 615 may manage output signals for the device 605. For example, the output module 615 may receive signals from other components of the device 605, such as the metric manager 620, and may transmit these signals to other components or devices. In some examples, the output module 615 may transmit output signals for display in a user interface, for storage in a database or data store, for further processing at a server or server cluster, or for any other processes at any number of devices or systems. In some cases, the output module 615 may be a component of an I/O controller 810 as described with reference to FIG. 8.

For example, the metric manager 620 may include a parent data object component 625, a metric suggestion object configuration component 630, a metric suggestion object generation component 635, a child data object analysis component 640, a metric suggestion component 645, or any combination thereof. In some examples, the metric manager 620, or various components thereof, may be configured to perform various operations (e.g., receiving, monitoring, transmitting) using or otherwise in cooperation with the input module 610, the output module 615, or both. For example, the metric manager 620 may receive information from the input module 610, send information to the output module 615, or be integrated in combination with the input module 610, the output module 615, or both to receive information, transmit information, or perform various other operations as described herein.

The metric manager 620 may support data processing at an application server in accordance with examples as disclosed herein. The parent data object component 625 may be configured as or otherwise support a means for generating a parent data object that comprises a plurality of child data objects. The metric suggestion object configuration component 630 may be configured as or otherwise support a means for receiving a metric suggestion object configuration that identifies a selection of data from a set of child data objects of the plurality of child data objects. The metric suggestion object generation component 635 may be configured as or otherwise support a means for generating a metric suggestion object associated with the parent data object based at least in part on the metric suggestion object configuration. The child data object analysis component 640 may be configured as or otherwise support a means for analyzing, with the metric suggestion object, the set of child data objects. The metric suggestion component 645 may be configured as or otherwise support a means for suggesting a metric and a metric range based at least in part on the analyzing, wherein the metric and the metric range are associated with the set of child data objects.

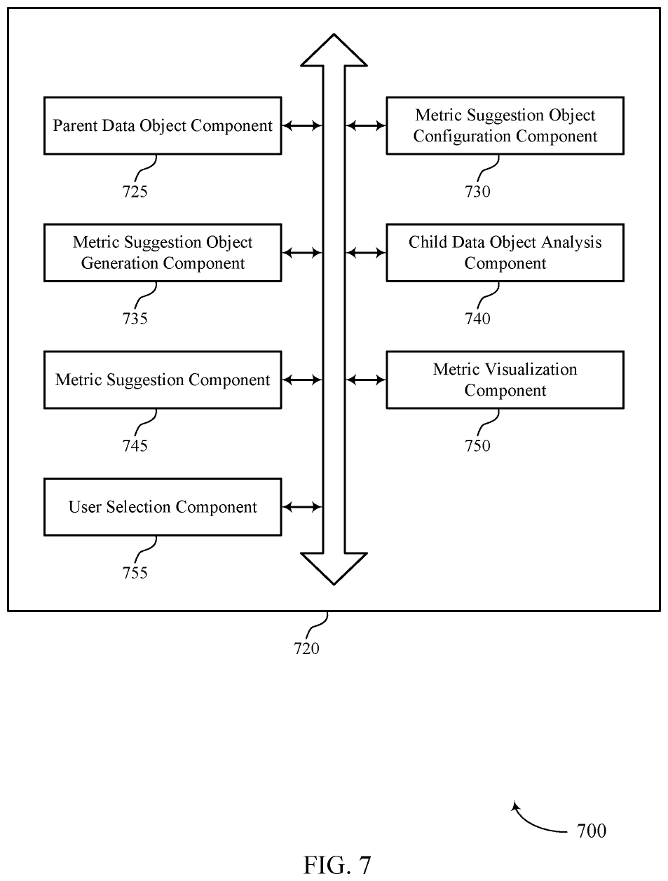

FIG. 7 shows a block diagram 700 of a metric manager 720 that supports metric suggestion for data objects in accordance with aspects of the present disclosure. The metric manager 720 may be an example of aspects of a metric manager or a metric manager 620, or both, as described herein. The metric manager 720, or various components thereof, may be an example of means for performing various aspects of metric suggestion for data objects as described herein. For example, the metric manager 720 may include a parent data object component 725, a metric suggestion object configuration component 730, a metric suggestion object generation component 735, a child data object analysis component 740, a metric suggestion component 745, a metric visualization component 750, a user selection component 755, or any combination thereof. Each of these components may communicate, directly or indirectly, with one another (e.g., via one or more buses).

The metric manager 720 may support data processing at an application server in accordance with examples as disclosed herein. The parent data object component 725 may be configured as or otherwise support a means for generating a parent data object that comprises a plurality of child data objects. The metric suggestion object configuration component 730 may be configured as or otherwise support a means for receiving a metric suggestion object configuration that identifies a selection of data from a set of child data objects of the plurality of child data objects. The metric suggestion object generation component 735 may be configured as or otherwise support a means for generating a metric suggestion object associated with the parent data object based at least in part on the metric suggestion object configuration. The child data object analysis component 740 may be configured as or otherwise support a means for analyzing, with the metric suggestion object, the set of child data objects. The metric suggestion component 745 may be configured as or otherwise support a means for suggesting a metric and a metric range based at least in part on the analyzing, wherein the metric and the metric range are associated with the set of child data objects.

In some examples, the child data object analysis component 740 may be configured as or otherwise support a means for determining a first metric type associated with a prior metric present in one or more of the set of child data objects, wherein the prior metric is associated with a previous performance of the selection of data from the set of child data objects.

In some examples, to support suggesting the metric and the metric range, the child data object analysis component 740 may be configured as or otherwise support a means for transforming the prior metric from the first metric type to a second metric type based at least in part on the analyzing.

In some examples, the child data object analysis component 740 may be configured as or otherwise support a means for determining an average value for the prior metric based at least in part on the previous performance of the selection of data. In some examples, the metric suggestion component 745 may be configured as or otherwise support a means for suggesting the average value as the metric.

In some examples, the child data object analysis component 740 may be configured as or otherwise support a means for determining a statistical deviation from the average value based at least in part on the previous performance of the selection of data. In some examples, the metric suggestion component 745 may be configured as or otherwise support a means for suggesting an upper limit of the metric range and a lower limit of the metric range based at least in part on the statistical deviation and a metric type of the metric.

In some examples, to support suggesting the metric and the metric range, the child data object analysis component 740 may be configured as or otherwise support a means for modifying the prior metric based at least in part on a second prior metric, a number of previous metrics measured, a metric comprised in a child data object of a second parent data object, a predetermined rate of change, an industry type, or a combination thereof. In some examples, to support suggesting the metric and the metric range, the metric suggestion component 745 may be configured as or otherwise support a means for suggesting the modified prior metric as the metric.

In some examples, the metric suggestion component 745 may be configured as or otherwise support a means for suggesting the metric range based at least in part on a metric type of the metric. In some examples, the metric visualization component 750 may be configured as or otherwise support a means for suggesting a visualization method for the metric and the metric range based at least in part on the analysis, a type of the metric, or a combination thereof. In some examples, to support receiving the metric suggestion object configuration, the user selection component 755 may be configured as or otherwise support a means for receiving a user selection of the set of child data objects and the selection of data from the set of child data objects. In some examples, the selection of data comprises a subset of data from the set of child data objects. In some examples, to support suggesting the metric and the metric range, the metric suggestion component 745 may be configured as or otherwise support a means for causing for display in a user interface an indication of the metric and an indication of the metric range displayed within the metric suggestion object.

In some examples, the child data object analysis component 740 may be configured as or otherwise support a means for determining an industry type associated with the set of child data objects. In some examples, the child data object analysis component 740 may be configured as or otherwise support a means for determining an amount of prior data available from one or more prior parent data objects. In some examples, the child data object analysis component 740 may be configured as or otherwise support a means for comparing the amount of prior data with a prior data threshold. In some examples, the metric suggestion component 745 may be configured as or otherwise support a means for suggesting the metric and the metric range based at least in part on the determined industry type and the amount of prior data being less than or equal to the prior data threshold.

In some examples, to support suggested metric, the metric suggestion component 745 may be configured as or otherwise support a means for an email send rate, an email open rate, a click rate, an unsubscribe rate, a total conversion value, a number of pageviews, a conversion rate, a number of goal completions, or a combination thereof.

FIG. 8 shows a diagram of a system 800 including a device 805 that supports metric suggestion for data objects in accordance with aspects of the present disclosure. The device 805 may be an example of or include the components of a device 605 as described herein. The device 805 may include components for bi-directional data communications including components for transmitting and receiving communications, such as a metric manager 820, an I/O controller 810, a database controller 815, a memory 825, a processor 830, and a database 835. These components may be in electronic communication or otherwise coupled (e.g., operatively, communicatively, functionally, electronically, electrically) via one or more buses (e.g., a bus 840).

The I/O controller 810 may manage input signals 845 and output signals 850 for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. In other cases, the I/O controller 810 may represent or interact with a modem, a keyboard, a mouse, a touchscreen, or a similar device. In some cases, the I/O controller 810 may be implemented as part of a processor 830. In some examples, a user may interact with the device 805 via the I/O controller 810 or via hardware components controlled by the I/O controller 810.

The database controller 815 may manage data storage and processing in a database 835. In some cases, a user may interact with the database controller 815. In other cases, the database controller 815 may operate automatically without user interaction. The database 835 may be an example of a single database, a distributed database, multiple distributed databases, a data store, a data lake, or an emergency backup database.

Memory 825 may include random-access memory (RAM) and ROM. The memory 825 may store computer-readable, computer-executable software including instructions that, when executed, cause the processor 830 to perform various functions described herein. In some cases, the memory 825 may contain, among other things, a BIOS which may control basic hardware or software operation such as the interaction with peripheral components or devices.

The processor 830 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 830 may be configured to operate a memory array using a memory controller. In other cases, a memory controller may be integrated into the processor 830. The processor 830 may be configured to execute computer-readable instructions stored in a memory 825 to perform various functions (e.g., functions or tasks supporting metric suggestion for data objects).

The metric manager 820 may support data processing at an application server in accordance with examples as disclosed herein. For example, the metric manager 820 may be configured as or otherwise support a means for generating a parent data object that comprises a plurality of child data objects. The metric manager 820 may be configured as or otherwise support a means for receiving a metric suggestion object configuration that identifies a selection of data from a set of child data objects of the plurality of child data objects. The metric manager 820 may be configured as or otherwise support a means for generating a metric suggestion object associated with the parent data object based at least in part on the metric suggestion object configuration. The metric manager 820 may be configured as or otherwise support a means for analyzing, with the metric suggestion object, the set of child data objects. The metric manager 820 may be configured as or otherwise support a means for suggesting a metric and a metric range based at least in part on the analyzing, wherein the metric and the metric range are associated with the set of child data objects.

By including or configuring the metric manager 820 in accordance with examples as described herein, the device 805 may support techniques for improved communication reliability, reduced latency, improved user experience related to reduced processing, reduced power consumption, more efficient utilization of communication resources, improved coordination between devices, longer battery life, improved utilization of processing capability, or a combination thereof.

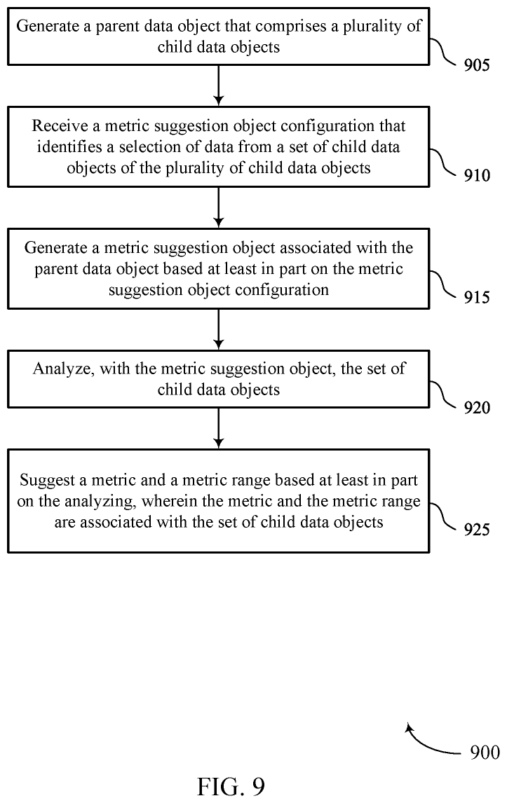

FIG. 9 shows a flowchart illustrating a method 900 that supports metric suggestion for data objects in accordance with aspects of the present disclosure. The operations of the method 900 may be implemented by an application server or its components as described herein. For example, the operations of the method 900 may be performed by an application server as described with reference to FIGS. 1 through 8. In some examples, an application server may execute a set of instructions to control the functional elements of the application server to perform the described functions. Additionally or alternatively, the application server may perform aspects of the described functions using special-purpose hardware.

At 905, the method may include generating a parent data object that comprises a plurality of child data objects. The operations of 905 may be performed in accordance with examples as disclosed herein. In some examples, aspects of the operations of 905 may be performed by a parent data object component 725 as described with reference to FIG. 7.

At 910, the method may include receiving a metric suggestion object configuration that identifies a selection of data from a set of child data objects of the plurality of child data objects. The operations of 910 may be performed in accordance with examples as disclosed herein. In some examples, aspects of the operations of 910 may be performed by a metric suggestion object configuration component 730 as described with reference to FIG. 7.

At 915, the method may include generating a metric suggestion object associated with the parent data object based at least in part on the metric suggestion object configuration. The operations of 915 may be performed in accordance with examples as disclosed herein. In some examples, aspects of the operations of 915 may be performed by a metric suggestion object generation component 735 as described with reference to FIG. 7.

At 920, the method may include analyzing, with the metric suggestion object, the set of child data objects. The operations of 920 may be performed in accordance with examples as disclosed herein. In some examples, aspects of the operations of 920 may be performed by a child data object analysis component 740 as described with reference to FIG. 7.

At 925, the method may include suggesting a metric and a metric range based at least in part on the analyzing, wherein the metric and the metric range are associated with the set of child data objects. The operations of 925 may be performed in accordance with examples as disclosed herein. In some examples, aspects of the operations of 925 may be performed by a metric suggestion component 745 as described with reference to FIG. 7.

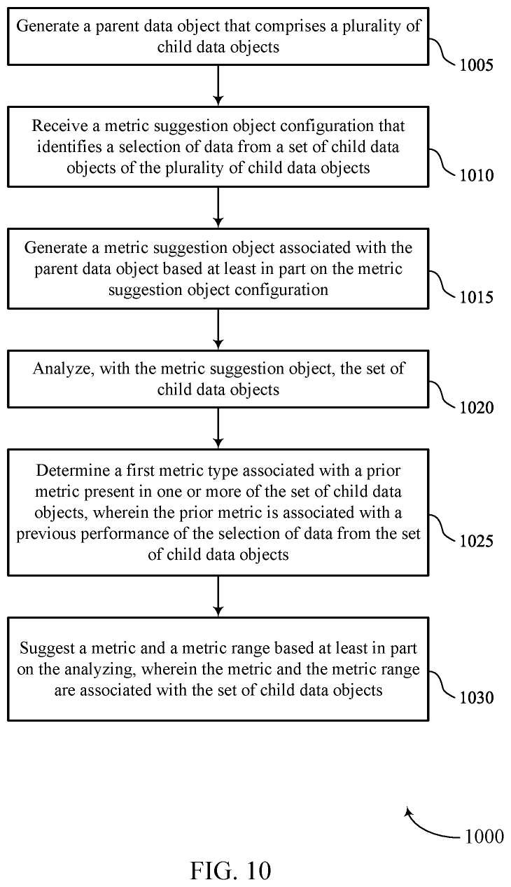

FIG. 10 shows a flowchart illustrating a method 1000 that supports metric suggestion for data objects in accordance with aspects of the present disclosure. The operations of the method 1000 may be implemented by an application server or its components as described herein. For example, the operations of the method 1000 may be performed by an application server as described with reference to FIGS. 1 through 8. In some examples, an application server may execute a set of instructions to control the functional elements of the application server to perform the described functions. Additionally or alternatively, the application server may perform aspects of the described functions using special-purpose hardware.

At 1005, the method may include generating a parent data object that comprises a plurality of child data objects. The operations of 1005 may be performed in accordance with examples as disclosed herein. In some examples, aspects of the operations of 1005 may be performed by a parent data object component 725 as described with reference to FIG. 7.

At 1010, the method may include receiving a metric suggestion object configuration that identifies a selection of data from a set of child data objects of the plurality of child data objects. The operations of 1010 may be performed in accordance with examples as disclosed herein. In some examples, aspects of the operations of 1010 may be performed by a metric suggestion object configuration component 730 as described with reference to FIG. 7.

At 1015, the method may include generating a metric suggestion object associated with the parent data object based at least in part on the metric suggestion object configuration. The operations of 1015 may be performed in accordance with examples as disclosed herein. In some examples, aspects of the operations of 1015 may be performed by a metric suggestion object generation component 735 as described with reference to FIG. 7.

At 1020, the method may include analyzing, with the metric suggestion object, the set of child data objects. The operations of 1020 may be performed in accordance with examples as disclosed herein. In some examples, aspects of the operations of 1020 may be performed by a child data object analysis component 740 as described with reference to FIG. 7.

At 1025, the method may include determining a first metric type associated with a prior metric present in one or more of the set of child data objects, wherein the prior metric is associated with a previous performance of the selection of data from the set of child data objects. The operations of 1025 may be performed in accordance with examples as disclosed herein. In some examples, aspects of the operations of 1025 may be performed by a child data object analysis component 740 as described with reference to FIG. 7.

At 1030, the method may include suggesting a metric and a metric range based at least in part on the analyzing, wherein the metric and the metric range are associated with the set of child data objects. The operations of 1030 may be performed in accordance with examples as disclosed herein. In some examples, aspects of the operations of 1030 may be performed by a metric suggestion component 745 as described with reference to FIG. 7.

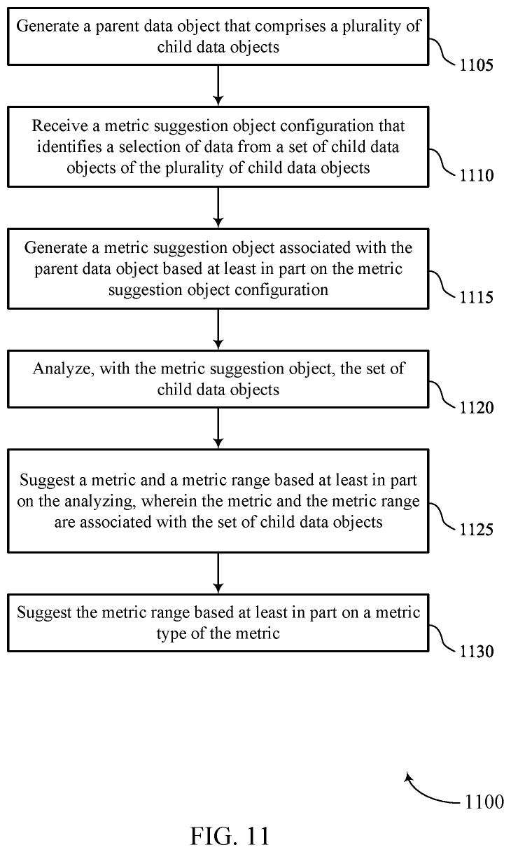

FIG. 11 shows a flowchart illustrating a method 1100 that supports metric suggestion for data objects in accordance with aspects of the present disclosure. The operations of the method 1100 may be implemented by an application server or its components as described herein. For example, the operations of the method 1100 may be performed by an application server as described with reference to FIGS. 1 through 8. In some examples, an application server may execute a set of instructions to control the functional elements of the application server to perform the described functions. Additionally or alternatively, the application server may perform aspects of the described functions using special-purpose hardware.

At 1105, the method may include generating a parent data object that comprises a plurality of child data objects. The operations of 1105 may be performed in accordance with examples as disclosed herein. In some examples, aspects of the operations of 1105 may be performed by a parent data object component 725 as described with reference to FIG. 7.

At 1110, the method may include receiving a metric suggestion object configuration that identifies a selection of data from a set of child data objects of the plurality of child data objects. The operations of 1110 may be performed in accordance with examples as disclosed herein. In some examples, aspects of the operations of 1110 may be performed by a metric suggestion object configuration component 730 as described with reference to FIG. 7.

At 1115, the method may include generating a metric suggestion object associated with the parent data object based at least in part on the metric suggestion object configuration. The operations of 1115 may be performed in accordance with examples as disclosed herein. In some examples, aspects of the operations of 1115 may be performed by a metric suggestion object generation component 735 as described with reference to FIG. 7.

At 1120, the method may include analyzing, with the metric suggestion object, the set of child data objects. The operations of 1120 may be performed in accordance with examples as disclosed herein. In some examples, aspects of the operations of 1120 may be performed by a child data object analysis component 740 as described with reference to FIG. 7.

At 1125, the method may include suggesting a metric and a metric range based at least in part on the analyzing, wherein the metric and the metric range are associated with the set of child data objects. The operations of 1125 may be performed in accordance with examples as disclosed herein. In some examples, aspects of the operations of 1125 may be performed by a metric suggestion component 745 as described with reference to FIG. 7.

At 1130, the method may include suggesting the metric range based at least in part on a metric type of the metric. The operations of 1130 may be performed in accordance with examples as disclosed herein. In some examples, aspects of the operations of 1130 may be performed by a metric suggestion component 745 as described with reference to FIG. 7.

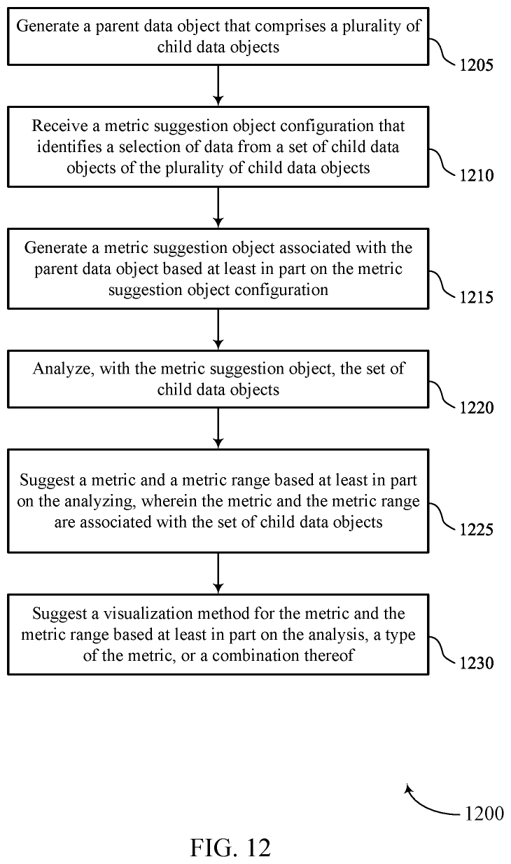

FIG. 12 shows a flowchart illustrating a method 1200 that supports metric suggestion for data objects in accordance with aspects of the present disclosure. The operations of the method 1200 may be implemented by an application server or its components as described herein. For example, the operations of the method 1200 may be performed by an application server as described with reference to FIGS. 1 through 8. In some examples, an application server may execute a set of instructions to control the functional elements of the application server to perform the described functions. Additionally or alternatively, the application server may perform aspects of the described functions using special-purpose hardware.

At 1205, the method may include generating a parent data object that comprises a plurality of child data objects. The operations of 1205 may be performed in accordance with examples as disclosed herein. In some examples, aspects of the operations of 1205 may be performed by a parent data object component 725 as described with reference to FIG. 7.

At 1210, the method may include receiving a metric suggestion object configuration that identifies a selection of data from a set of child data objects of the plurality of child data objects. The operations of 1210 may be performed in accordance with examples as disclosed herein. In some examples, aspects of the operations of 1210 may be performed by a metric suggestion object configuration component 730 as described with reference to FIG. 7.

At 1215, the method may include generating a metric suggestion object associated with the parent data object based at least in part on the metric suggestion object configuration. The operations of 1215 may be performed in accordance with examples as disclosed herein. In some examples, aspects of the operations of 1215 may be performed by a metric suggestion object generation component 735 as described with reference to FIG. 7.

At 1220, the method may include analyzing, with the metric suggestion object, the set of child data objects. The operations of 1220 may be performed in accordance with examples as disclosed herein. In some examples, aspects of the operations of 1220 may be performed by a child data object analysis component 740 as described with reference to FIG. 7.

At 1225, the method may include suggesting a metric and a metric range based at least in part on the analyzing, wherein the metric and the metric range are associated with the set of child data objects. The operations of 1225 may be performed in accordance with examples as disclosed herein. In some examples, aspects of the operations of 1225 may be performed by a metric suggestion component 745 as described with reference to FIG. 7.

At 1230, the method may include suggesting a visualization method for the metric and the metric range based at least in part on the analysis, a type of the metric, or a combination thereof. The operations of 1230 may be performed in accordance with examples as disclosed herein. In some examples, aspects of the operations of 1230 may be performed by a metric visualization component 750 as described with reference to FIG. 7.

A method for data processing at an application server is described. The method may include generating a parent data object that comprises a plurality of child data objects, receiving a metric suggestion object configuration that identifies a selection of data from a set of child data objects of the plurality of child data objects, generating a metric suggestion object associated with the parent data object based at least in part on the metric suggestion object configuration, analyzing, with the metric suggestion object, the set of child data objects, and suggesting a metric and a metric range based at least in part on the analyzing, wherein the metric and the metric range are associated with the set of child data objects.

An apparatus for data processing at an application server is described. The apparatus may include a processor, memory coupled with the processor, and instructions stored in the memory. The instructions may be executable by the processor to cause the apparatus to generate a parent data object that comprises a plurality of child data objects, receive a metric suggestion object configuration that identifies a selection of data from a set of child data objects of the plurality of child data objects, generate a metric suggestion object associated with the parent data object based at least in part on the metric suggestion object configuration, analyze, with the metric suggestion object, the set of child data objects, and suggest a metric and a metric range based at least in part on the analyzing, wherein the metric and the metric range are associated with the set of child data objects.

Another apparatus for data processing at an application server is described. The apparatus may include means for generating a parent data object that comprises a plurality of child data objects, means for receiving a metric suggestion object configuration that identifies a selection of data from a set of child data objects of the plurality of child data objects, means for generating a metric suggestion object associated with the parent data object based at least in part on the metric suggestion object configuration, means for analyzing, with the metric suggestion object, the set of child data objects, and means for suggesting a metric and a metric range based at least in part on the analyzing, wherein the metric and the metric range are associated with the set of child data objects.

A non-transitory computer-readable medium storing code for data processing at an application server is described. The code may include instructions executable by a processor to generate a parent data object that comprises a plurality of child data objects, receive a metric suggestion object configuration that identifies a selection of data from a set of child data objects of the plurality of child data objects, generate a metric suggestion object associated with the parent data object based at least in part on the metric suggestion object configuration, analyze, with the metric suggestion object, the set of child data objects, and suggest a metric and a metric range based at least in part on the analyzing, wherein the metric and the metric range are associated with the set of child data objects.

Some examples of the method, apparatuses, and non-transitory computer-readable medium described herein may further include operations, features, means, or instructions for determining a first metric type associated with a prior metric present in one or more of the set of child data objects, wherein the prior metric may be associated with a previous performance of the selection of data from the set of child data objects.

In some examples of the method, apparatuses, and non-transitory computer-readable medium described herein, suggesting the metric and the metric range may include operations, features, means, or instructions for transforming the prior metric from the first metric type to a second metric type based at least in part on the analyzing.

Some examples of the method, apparatuses, and non-transitory computer-readable medium described herein may further include operations, features, means, or instructions for determining an average value for the prior metric based at least in part on the previous performance of the selection of data and suggesting the average value as the metric.

Some examples of the method, apparatuses, and non-transitory computer-readable medium described herein may further include operations, features, means, or instructions for determining a statistical deviation from the average value based at least in part on the previous performance of the selection of data and suggesting an upper limit of the metric range and a lower limit of the metric range based at least in part on the statistical deviation and a metric type of the metric.

In some examples of the method, apparatuses, and non-transitory computer-readable medium described herein, suggesting the metric and the metric range may include operations, features, means, or instructions for modifying the prior metric based at least in part on a second prior metric, a number of previous metrics measured, a metric comprised in a child data object of a second parent data object, a predetermined rate of change, an industry type, or a combination thereof and suggesting the modified prior metric as the metric.

Some examples of the method, apparatuses, and non-transitory computer-readable medium described herein may further include operations, features, means, or instructions for suggesting the metric range based at least in part on a metric type of the metric.

Some examples of the method, apparatuses, and non-transitory computer-readable medium described herein may further include operations, features, means, or instructions for suggesting a visualization method for the metric and the metric range based at least in part on the analysis, a type of the metric, or a combination thereof.

In some examples of the method, apparatuses, and non-transitory computer-readable medium described herein, receiving the metric suggestion object configuration may include operations, features, means, or instructions for receiving a user selection of the set of child data objects and the selection of data from the set of child data objects.

In some examples of the method, apparatuses, and non-transitory computer-readable medium described herein, the selection of data comprises a subset of data from the set of child data objects.

In some examples of the method, apparatuses, and non-transitory computer-readable medium described herein, suggesting the metric and the metric range may include operations, features, means, or instructions for causing for display in a user interface an indication of the metric and an indication of the metric range displayed within the metric suggestion object.

Some examples of the method, apparatuses, and non-transitory computer-readable medium described herein may further include operations, features, means, or instructions for determining an industry type associated with the set of child data objects, determining an amount of prior data available from one or more prior parent data objects, comparing the amount of prior data with a prior data threshold, and suggesting the metric and the metric range based at least in part on the determined industry type and the amount of prior data being less than or equal to the prior data threshold.

In some examples of the method, apparatuses, and non-transitory computer-readable medium described herein, the suggested metric may include operations, features, means, or instructions for an email send rate, an email open rate, a click rate, an unsubscribe rate, a total conversion value, a number of pageviews, a conversion rate, a number of goal completions, or a combination thereof.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, a field-programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a digital signal processor (DSP) and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable ROM (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for data processing at an application server, comprising:
generating a parent data object that comprises a plurality of child data objects;
receiving a metric suggestion object configuration that identifies a selection of data from a set of child data objects of the plurality of child data objects;
generating a metric suggestion object associated with the parent data object based at least in part on the metric suggestion object configuration;
analyzing, with the metric suggestion object, the set of child data objects; and
suggesting a metric and a metric range based at least in part on the analyzing, wherein the metric and the metric range are associated with the set of child data objects.

2. The method of claim 1, further comprising:
determining a first metric type associated with a prior metric present in one or more of the set of child data objects, wherein the prior metric is associated with a previous performance of the selection of data from the set of child data objects.

3. The method of claim 2, wherein suggesting the metric and the metric range comprises:
transforming the prior metric from the first metric type to a second metric type based at least in part on the analyzing.

4. The method of claim 2, further comprising:
determining an average value for the prior metric based at least in part on the previous performance of the selection of data; and
suggesting the average value as the metric.

5. The method of claim 4, further comprising:
determining a statistical deviation from the average value based at least in part on the previous performance of the selection of data; and
suggesting an upper limit of the metric range and a lower limit of the metric range based at least in part on the statistical deviation and a metric type of the metric.

6. The method of claim 2, wherein suggesting the metric and the metric range comprises:
modifying the prior metric based at least in part on a second prior metric, a number of previous metrics measured, a metric comprised in a child data object of a second parent data object, a predetermined rate of change, an industry type, or a combination thereof and
suggesting the modified prior metric as the metric.

7. The method of claim 1, further comprising:
suggesting the metric range based at least in part on a metric type of the metric.

8. The method of claim 1, further comprising:
suggesting a visualization method for the metric and the metric range based at least in part on the analysis, a type of the metric, or a combination thereof.

9. The method of claim 1, wherein receiving the metric suggestion object configuration comprises:
receiving a user selection of the set of child data objects and the selection of data from the set of child data objects.

10. The method of claim 9, wherein the selection of data comprises a subset of data from the set of child data objects.

11. The method of claim 1, wherein suggesting the metric and the metric range comprises:
causing for display in a user interface an indication of the metric and an indication of the metric range displayed within the metric suggestion object.

12. The method of claim 1, further comprising:
determining an industry type associated with the set of child data objects;
determining an amount of prior data available from one or more prior parent data objects;
comparing the amount of prior data with a prior data threshold; and
suggesting the metric and the metric range based at least in part on the determined industry type and the amount of prior data being less than or equal to the prior data threshold.

13. The method of claim 1, wherein the suggested metric comprises:
an email send rate, an email open rate, a click rate, an unsubscribe rate, a total conversion value, a number of pageviews, a conversion rate, a number of goal completions, or a combination thereof.

14. An apparatus for data processing at an application server, comprising:
a processor;
memory coupled with the processor; and
instructions stored in the memory and executable by the processor to cause the apparatus to:
generate a parent data object that comprises a plurality of child data objects;
receive a metric suggestion object configuration that identifies a selection of data from a set of child data objects of the plurality of child data objects;
generate a metric suggestion object associated with the parent data object based at least in part on the metric suggestion object configuration;
analyze, with the metric suggestion object, the set of child data objects; and
suggest a metric and a metric range based at least in part on the analyzing, wherein the metric and the metric range are associated with the set of child data objects.

15. The apparatus of claim 14, wherein the instructions are further executable by the processor to cause the apparatus to:
determine a first metric type associated with a prior metric present in one or more of the set of child data objects, wherein the prior metric is associated with a previous performance of the selection of data from the set of child data objects.

16. The apparatus of claim 14, wherein the instructions are further executable by the processor to cause the apparatus to:
suggest the metric range based at least in part on a metric type of the metric.

17. The apparatus of claim 14, wherein the instructions are further executable by the processor to cause the apparatus to:
suggest a visualization method for the metric and the metric range based at least in part on the analysis, a type of the metric, or a combination thereof.

18. The apparatus of claim 14, wherein the instructions to suggest the metric and the metric range are executable by the processor to cause the apparatus to:
cause for display in a user interface an indication of the metric and an indication of the metric range displayed within the metric suggestion object.

19. The apparatus of claim 14, wherein the instructions are further executable by the processor to cause the apparatus to:
determine an industry type associated with the set of child data objects;
determine an amount of prior data available from one or more prior parent data objects;
compare the amount of prior data with a prior data threshold; and
suggest the metric and the metric range based at least in part on the determined industry type and the amount of prior data being less than or equal to the prior data threshold.

20. A non-transitory computer-readable medium storing code for data processing at an application server, the code comprising instructions executable by a processor to:
generate a parent data object that comprises a plurality of child data objects;
receive a metric suggestion object configuration that identifies a selection of data from a set of child data objects of the plurality of child data objects;
generate a metric suggestion object associated with the parent data object based at least in part on the metric suggestion object configuration;
analyze, with the metric suggestion object, the set of child data objects; and
suggest a metric and a metric range based at least in part on the analyzing, wherein the metric and the metric range are associated with the set of child data objects.
